(19) United States
(12) Patent Application Publication
(10) Pub. No.: US 2008/0068578 A1
(43) Pub. Date: Mar. 20, 2008

(54) PROJECTION ALIGNER INCLUDING CORRECTION FILTERS

(76) Inventor: Norihiro Sakumichi, Kawasaki (JP)

Correspondence Address: HAYES SOLOWAY P.C., 3450 E. SUNRISE DRIVE, SUITE 140, TUCSON, AZ, 85718, US

(21) Appl. No.: 11/850,596

(22) Filed: Sep. 5, 2007

(30) Foreign Application Priority Data
Sep. 15, 2006 (JP) 2006-251478

(51) Int. Cl. G03B 27/72

(52) U.S. Cl. 355/71

(57) ABSTRACT

A projection aligner includes an illumination optical system which irradiates a mask pattern with an exposure light, an exposure optical system which irradiates a substrate on a stage with the exposure light passed by the illumination optical system, and a correction optical system including two correction filters for correcting the illuminance irregularity of the exposure light. The correction filters have a light transmission irregularity which is opposite to the illuminance irregularity of the projection aligner. The two correction filters are shifted from each other so that the transmittance distributions of both the correction filters are shifted from one another.

This application is based upon and claims the benefit of priority from Japanese patent application No. 2006-251478, the disclosure of which is incorporated herein in its entirety by reference.

### BACKGROUND OF THE INVENTION

(a) Field of the Invention

The present invention relates to a projection aligner for projecting a mask pattern onto a substrate disposed on an exposure stage by using an exposure light. The present invention also relates to a method for manufacturing a correction filter for correcting the illuminance irregularity of the projection aligner.

(b) Description of the Related Art

Projection aligners are used in the process for manufacturing a liquid crystal (LC) panel or a semiconductor device. The projection aligner generally includes an illumination optical system which irradiates exposure light emitted by a light source onto a photomask which has thereon a light transmission pattern, and a projection optical system which irradiates the exposure light passed by the photomask onto an exposure stage. In the process for manufacturing a LC panel, a glass (transparent) substrate including thereon a photoresist film having a photosensitive property is mounted on the exposure stage, and the light transmission pattern formed on the photomask is transferred onto the photoresist film.

The exposure light irradiated onto the substrate by using the projection aligner generally has an illuminance irregularity resulting from the characteristics of the optical system. Along with the development of a finer pattern on the LC panel in recent years, only a low degree of illuminance irregularity may degrade the image quality of the product LCD devices for example, considering a large-size LC panel manufactured by a step-and-repeat process in which the LC panel is divided into a plurality of areas for iterative exposure, the illuminance irregularity, if occurs, will generate a cyclic defect in the vicinity of each boundary of the divided areas of the LC panel.

In order to reduce the illuminance irregularity of the conventional projection aligner, an integrator lens (fly-eye lens) is disposed in the vicinity of the light source for equalizing the in-plane intensity of the exposure light on a plane perpendicular to the optical axis of the exposure light. However, even the use of the integrator lens cannot well cancel the influence by a system-specific illuminance irregularity of the projection aligner. Thus, it is indispensable to correct the illuminance irregularity corresponding to each projection aligner in consideration of the system-specific illuminance irregularity.

Patent Publication JP-1986-150330A describes an illuminance-irregularity correction filter which corrects the system-specific illuminance irregularity of the projection aligner. In the technique described in the patent publication, a photomask having thereon an array of light transmission patterns is used to expose a negative-type photoresist film to the exposure light during manufacture of the correction filter. The photoresist pattern obtained from the photoresist film thus exposed and then developed is used for patterning an underlying light shield film.

The photoresist pattern formed as above includes an array of patterns, for example, corresponding to the light transmission patterns of the photomask. The array of patterns reflect the illuminance irregularity of the projection aligner, and thus include a larger-size pattern corresponding to the higher illuminance in the illuminance irregularity and a smaller-size pattern corresponding to the lower illuminance therein. The transfer of the photoresist pattern onto the light shield film provides a correction filter having a transmittance distribution which is opposite to the illuminance distribution of the projection aligner.

In the technique of the above patent publication, the correction filter having the transmittance distribution opposite to the inherent illuminance distribution of the projection aligner is manufactured using the same projection aligner and disposed in the optical path of the illumination optical system of the projection aligner for correction of the illuminance irregularity.

The present inventor noticed that it is generally difficult to provide an optimum range of irregularity in the transmittance distribution of the correction filter for cancelling the illuminance irregularity of the projection aligner. If the correction filter obtained by the above process proves an insufficient function for compensating the illuminance irregularity of the projection aligner, another correction filter should be manufactured after changing the exposure conditions of the projection aligner, such as the exposure time length. This may consume a longer time and a higher cost in the process for manufacturing the correction filter, to cause a longer turn around time and a higher cost for the product LCD devices. Thus, a projection aligner is desired which can easily adjust the range of irregularity of the correction filter which corrects the illuminance irregularity of the same projection aligner.

### SUMMARY OF THE INVENTION

It is an object of the present invention to provide a projection aligner and a projection aligning process which is capable of manufacturing a correction filter while adjusting the range of transmittance irregularity to effectively correct the illuminance irregularity of the projection aligner.

It is another object of the present invention to provide a method for manufacturing the correction filter as described above.

The present invention provides a projection aligner including: an exposure optical system for irradiating a mask pattern with an exposure light for projecting the mask pattern onto a substrate mounted on an exposure stage; and a plurality of correction filters juxtaposed with one another in the exposure optical system, the correction filters each having a transmittance distribution which is opposite to an inherent illuminance distribution of the exposure optical system, at least two of the correction filters are arranged so that the transmittance distributions of the at least two of the correction filters are shifted from each other in a direction perpendicular to an optical axis of the exposure optical system.

The present invention also provides a method including the steps: consecutively forming a light shield film and a negative-type photoresist film on a transparent substrate; exposing the photoresist film to an exposure light of a projection aligner including an exposure optical system and a correction optical system while using a neutral density filter in the correction optical system; developing the exposed photoresist film to form a photoresist pattern; patterning the light shield film by using the photoresist pattern as an etching mask to form a correction filter having a transmittance distribution which is opposite to an inherent illuminance distribution of the exposure optical system; and iterating above the steps to form a plurality of the correction filters.

The present invention also provides a method including: irradiating a mask pattern with an exposure light for projecting the mask pattern onto a substrate mounted on an exposure stage, the exposure light being passed by a plurality of correction filters each having a transmittance distribution which is opposite to an inherent illuminance distribution of the exposure optical system, and shifting at least one of the correction filters so that the transmittance distributions of the at least one of the correction filters is shifted from another of the correction filters in a direction perpendicular to an optical axis of the exposure optical system.

The above and other objects, features and advantages of the present invention will be more apparent from the following description, referring to the accompanying drawings.

### BRIEF DESCRIPTION OF THE DRAWINGS

FIG. 1 is a side view of a projection aligner according to an exemplary embodiment of the present invention.

FIG. 2 is a side view of the combination correction filter shown in FIG. 1.

FIG. 3 is a top plan view of the photomask used for manufacturing the combination correction filter.

FIGS. 4A to 4C are sectional views showing consecutive steps of a process for manufacturing a correction filter in the combination correction filter.

FIG. 5 is a top plan view of the correction filter.

FIG. 6 is a flowchart showing a projection aligning process using the combination correction filter.

FIG. 7A is an enlarged partial side view of the combination correction filter of FIG. 2, and FIG. 7B is a front view of the light shield pattern as viewed from the light emitting side of the combination correction filter.

FIG. 8 is a graph showing the relationship between the light transmittance and the shift amount of samples of the combination correction filter shown in FIG. 7.

FIG. 9 is a graph showing the illuminance distribution on the exposure stage in the absence of a correction filter.

FIGS. 10A and 10B show transmittance distributions of a single correction filter and two correction filters, respectively.

FIG. 11 is a graph showing the illuminance distribution obtained upon disposing the combination correction filter.

FIG. 12 is a front view of the light shield pattern in a modification of the projection aligner of the above embodiment.

### PREFERRED EMBODIMENT OF THE INVENTION

Now, an exemplary embodiment according to the present invention will be described with reference to accompanying drawings.

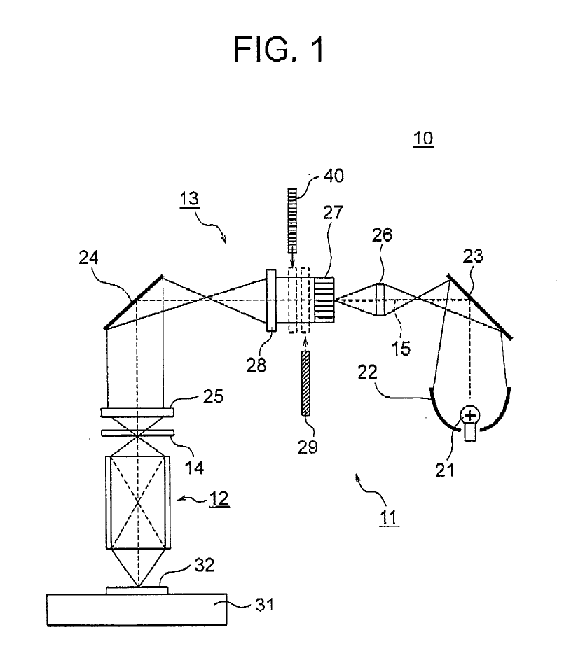

FIG. 1 is a side view showing the structure of a projection aligner according to the embodiment of the present invention. The projection aligner, generally designated at numeral 10, is used in a photolithographic process for manufacturing an illuminance-irregularity correction filter as well as in a photolithographic process for manufacturing a LC panel or a semiconductor device by using the correction filters thus manufactured.

The projection aligner 10 includes an illumination optical system 11 which irradiates exposure light onto a photomask 14, and a projection optical system 12 which projects the exposure light passed by the photomask 14 onto the exposure stage 31. The illumination optical system 11 includes therein a correction optical system 13 which corrects the exposure light of the illumination optical system 11. A photomask 14 is mounted on a mask stage not illustrated in the figure. In a photolithographic process, a substrate 32 on which a photoresist film is formed is mounted on an exposure stage 31. The substrate 32 may be a glass substrate or a semiconductor wafer, for example. The light emitted from the light source 21 advances along the optical axis 15 of the projection aligner 10 to be incident onto the substrate 32.

The illumination optical system 11 includes the light source 21 for emitting an ultraviolet ray through the illumination optical system 11 as an exposure light, an elliptical mirror 22 which reflects the exposure light emitted from the light source 21, a mirror 23 which reflects the exposure light reflected by the elliptical mirror 22 toward the correction optical system 13, and a focusing lens 25 which condenses the exposure light reflected by the mirror 24 to be incident onto the photomask 14. The light source 21 includes, for example, a mercury lamp. The projection optical system 12 is configured by a lens group.

The correction optical system 13 includes, consecutively from the light incident side thereof, an input lens 26, an optical integrator 27, a combination correction filter 40 for correcting the illuminance irregularity of the projection aligner 10, and a lens 28. The input lens 26 allows the exposure light reflected by the mirror 23 to be incident onto the optical integrator 27. The optical integrator 27 includes a plurality of minute lenses arranged in a plane perpendicular to the optical axis 15, and configures a two-dimensional optical source having a uniform illuminance distribution as viewed on the light emitting surface of the optical integrator 27 perpendicular to the optical axis 15.

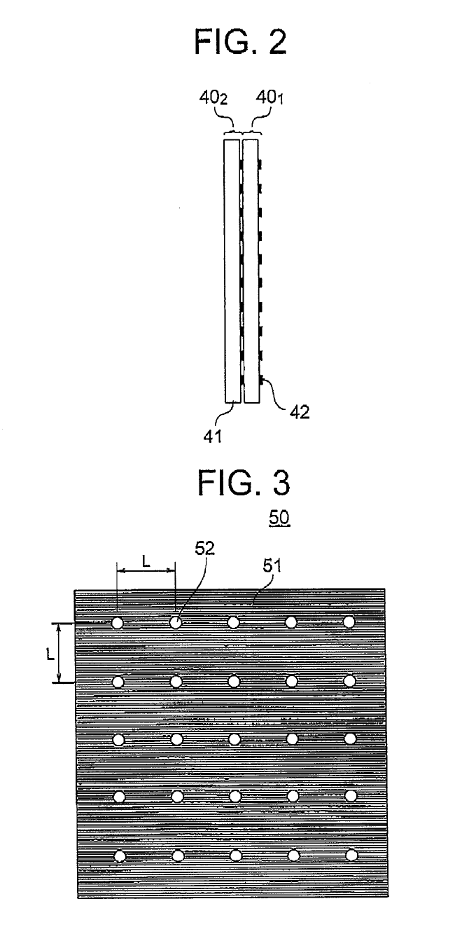

The combination correction filter 40 is disposed for the purpose of correcting the illuminance irregularity of the exposure light, which is to be projected onto the substrate 32 on the exposure stage 31. Upon arrangement of the correction filter 40, as shown in FIG. 2, a pair of correction filters 40₁, 40₂ having thereon similar patterns is arranged in the direction of the optical axis 15. The two correction filters 40₁, 40₂ may be arranged in contact with or apart from one another. These correction filters 40₁ and 40₂ are manufactured using the projection aligner 10 of FIG. 1.

FIG. 3 is a top plan view showing the structure of the photomask used for manufacturing the combination correction filter 40 of FIG. 2. The photomask 50 has a light shield area or background 51 having a light transmittance of about 1 to 5%, and an array of circular light transmission patterns 52 arranged in a two-dimensional array at a predetermined pitch L. The pitch L of the light transmission patterns 52 is about 200 micrometers, and the diameter of each light transmission pattern 52 is about 20 micrometers. The light transmission patterns 52 may be of any shape, and may have a rectangular shape, for example, instead of the circular shape. The light transmission patterns 52 are preferably formed at a uniform pitch or density on the photomask 50. The light transmission patterns 52 may be formed on the entire surface of the photomask 50 or may be arranged in a square grid or in a zigzag arrangement.

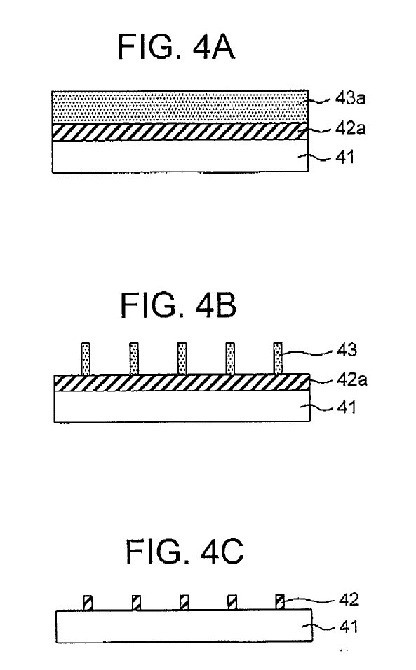

FIGS. 4A to 4C are sectional views of a correction filter of the combination correction filter 40 in consecutive steps of a process for manufacturing the same. A metallic film 42a is first formed to a thickness of 1000 to 3000 angstroms on the glass substrate 41, as shown in FIG. 4A, which configures the body of the correction filter. Thereafter, a photoresist film 43a of a negative type is formed on the metallic thin film 42a by coating to a thickness of about 2.5 to 4.0 micrometers on the metallic thin film 42a. Examples of the material for the glass substrate 41 include quartz having a small coefficient of thermal expansion, and examples of the material for the metallic thin film 42a include Cr, Mo, and Ti. The photoresist film 43a has a thickness of double to quadruple of the usual thickness because the exposure time length is relatively long and the developed photoresist pattern should preferably have a larger difference in the thickness thereof. In an alternative, a photoresist film having a lower exposure sensitivity may be used if a larger thickness difference is not assured.

Subsequently, the glass substrate 41 is mounted on the exposure stage 31. Here, as shown in FIG. 1, a ND (neutral density) filter 29 is arranged on the optical axis of the correction optical system 13. The ND filter 29 is used to decrease the light intensity, increase the illuminance irregularity, increase the exposure time length, and thus increase the thickness difference in the resultant resist pattern after development. The photomask 50 is disposed on the mask stage.

After exposure of the photoresist film 43a to the exposure light with the ND filter 29 being used, a baking treatment is performed to the photoresist film 43a. Thereafter, an alkaline developing treatment is performed using a TMAH developer, to remove the unexposed portion of the photoresist film 43a, to thereby form a resist pattern 43 having arrangement and shape corresponding to those of the light transmission patterns 52 of the photomask, as shown in FIG. 4B. Subsequently, the resist pattern 43 thus formed is used as an etching mask to pattern the metallic film 42a, thereby obtaining an array of light shield patterns 42. The photoresist pattern 43 is then removed to complete the correction filter, as shown in FIG. 4C.

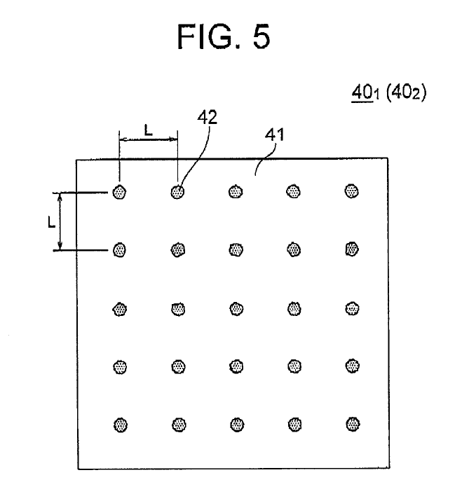

FIG. 5 is a top plan view showing the pattern structure of the correction filter 40₁ (or 40₂). The correction filter 40₁ includes an array of light shield patterns 42 in the shape and arrangement corresponding to the shape and arrangement of the light transmission patterns 52 of the photomask. The light shield patterns 42 and the light transmission pattern 52 of the photomask have therebetween a negative-positive relationship with respect to one another. By using the same conditions, a plurality of correction filters of the combination correction filter 40 are formed.

In the manufacture of the correction filters, the exposure light passed by the light transmission patterns 52 of the photomask 50 is irradiated onto the photoresist film 43a during exposure of the photoresist film 43a to the exposure light. In this circumstance, the exposure light reflecting the system-specific illuminance irregularity characteristic of the target projection aligner 10 is incident onto the surface of the photoresist film 43a, whereby each pattern of the resist pattern 43 is formed in the dimension based on the illuminance of the corresponding portion of the exposure light. More specifically, the dimension of each light shield pattern 42 formed using the resist pattern 43 corresponds to the illuminance of the portion of the exposure light, whereby the entire pattern of the light shied patterns 42 has a dimension distribution corresponding to the system-specific illuminance irregularity of the projection aligner 10. Therefore, a correction filter having a transmittance distribution which is opposite to the illuminance irregularity of the projection aligner 10 can be obtained.

Although the correction filters may be formed without using a ND filter, as described in JP-1986-150330A, use of the ND filter 29 enhances the in-plane dimension difference between the light shield patterns 42 of the correction filter, and thus is preferable.

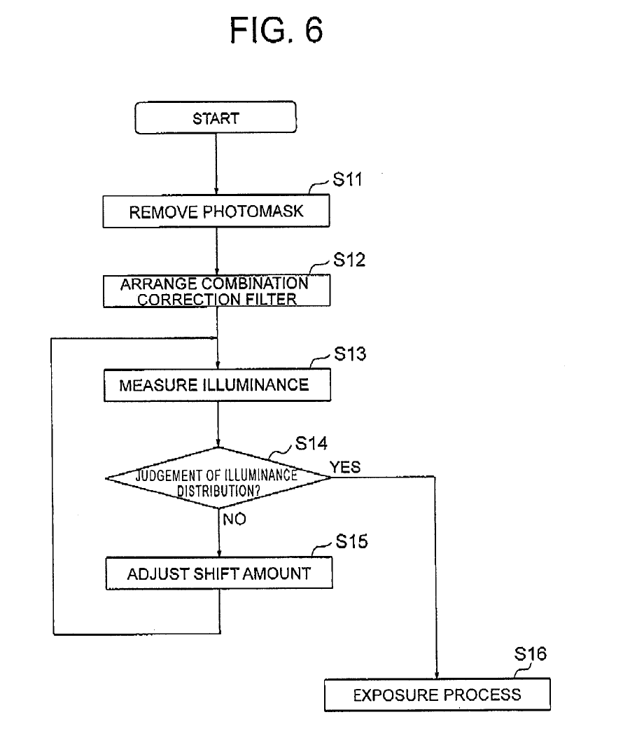

FIG. 6 shows a procedure for correcting the illuminance irregularity by using the combination correction filter including the correction filters of FIG. 5 in a flowchart. The photomask 50 used for manufacturing the combination correction filter 40 is removed (step S11). Subsequently, as shown in FIG. 2, the combination correction filter 40 including two correction filters 40₁, 40₂ is arranged between the optical integrator 27 and the lens 28 of the correction optical system 13 (step S12).

During arrangement of the combination correction filter 40, the combination correction filter 40 is slightly shifted in the direction of the optical axis from the location at which the combination correction filter 40 is conjugate with the photomask 14. In addition, the combination correction filter 40 is disposed in the direction so that the combination correction filter 40 cancels the illuminance irregularity of the projection aligner 10. The two correction filters 40₁, 40₂ of the combination correction filter 40 are disposed so that the first correction filter 40₁ of the light incident side is disposed movable in the direction perpendicular to the optical axis of the exposure light, and the second correction filter 40₂ of the light emitting side is fixed. It is to be noted that any of the correction filters 40₁, 40₂ may be movably disposed.

Subsequently, the illuminance irregularity of the projection aligner 10 is measured on the exposure stage 31 without arrangement of the photomask 14 (step S13). The measurement of illuminance irregularity uses a photosensor which is capable of measuring the wave length of the exposure light, and measures the illuminance of a plurality of divided areas obtained by dividing the entire exposure area at a specific pitch. After measurement of the illuminance of the plurality of divided areas, range of variation of the illuminance is obtained by calculating the difference between the maximum illuminance and the minimum illuminance, followed by comparing the calculated difference against a predetermined reference value, to judge whether or not the difference is within a specific allowable range (step S14).

If it is judged that the range of illuminance irregularity is within the specific range at step S14, the process advances to an exposure process for manufacturing a LC panel (step S16). On the other hand, if the difference is out of the specific range, the first correction filter 40₁ is shifted by a specific amount in the direction perpendicular to the optical axis, for adjusting the correction amount by the combination correction filter 40 (step S15). The process then returns to step S13 to judge whether or not the difference is within the specific range. The steps S13 to S15 are iterated until a desired illuminance irregularity is obtained, or a shift amount providing a minimum illuminance irregularity is obtained.

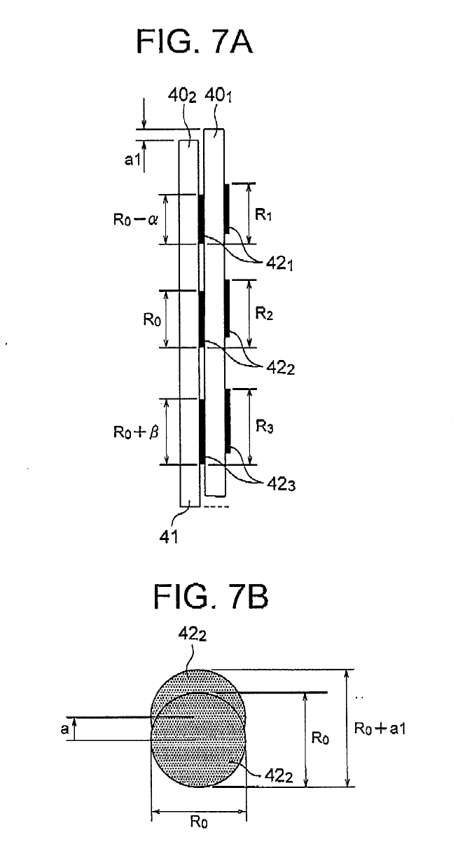

FIG. 7A is an enlarged partial side view of the combination correction filter 40 shown in FIG. 2, whereas FIG. 7D is the front view of the light shield pattern as viewed from the light emitting side of the combination correction filter 40. In FIG. 7A, it is assumed here that the diameter R0 of the light shield patterns 42₂ is an average diameter of the light shield patterns 42₁ the diameter of the light shield patterns 42₁ is R0−α (α>0), and the diameter of the light shield patterns 42₃ is R0+β (▭>0). It is also assumed that the shift amount of the first correction filter 41 is a1 (a1>0). R1 to R3 are overall dimensions of the light shield patterns 42₁, 42₂ and 42₃, respectively, by which the combination correction filters 40₁, 40₂ effectively intercept the exposure light, in the shift direction of the correction filter 40₁.

In the above assumption, the following relationship holds:

R1=R0−α+a1;

R2=R0+a1; and

R3=R0+β+a1.

The overall dimensions R1 to R3 increase equally with an increase of the shift amount a1. However, the overall area of each pattern 42₁, 42₂, 42₃ of the combination correction filter 40 increases with the increase of the shift amount a1 in a larger amount than the increase of the dimensions R1 to R3, because the width of the overall pattern as measured in the direction perpendicular to the shifted direction is different among these overall patterns 42₁, 42₂, 42₃. More specifically, the difference in the effective shield area among these patterns 42₁, 42₂, 42₃ increases with the increase of the shift amount a1.

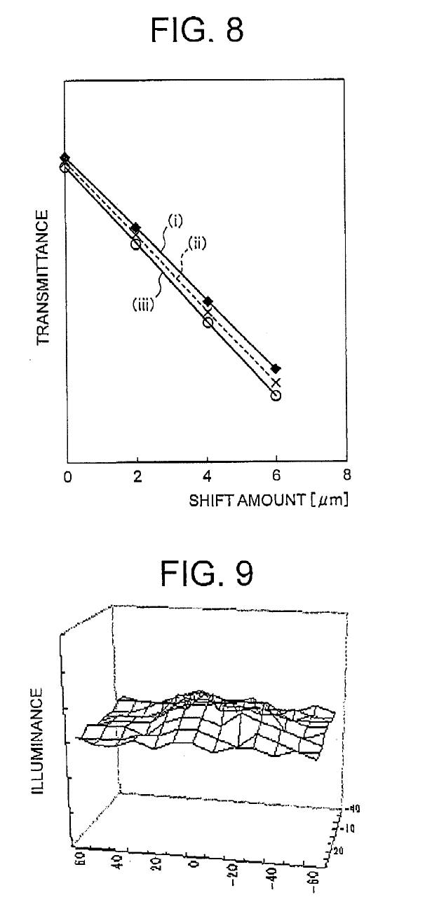

FIG. 8 shows the relationship between the shift amount a1 and the transmittance of the combination correction filter 40 in the vicinity of the light shield patterns 42₁, 42₂, 42₃, wherein graphs (i), (ii) and (iii) correspond to light shield patterns 42₁, 42₂ and 42₃, respectively. The shift amount a1 is changed from 0 to 6 micrometers in FIG. 8, for both the α and β being equal to 0.4 micrometers, in this example. As understood from FIG. 8, the increase of shift amount a1 reduces the overall transmittance in the vicinity of the light shield patterns, and also increases the difference of the overall transmittance among the light shield patterns 42₁, 42₂, 42₃.

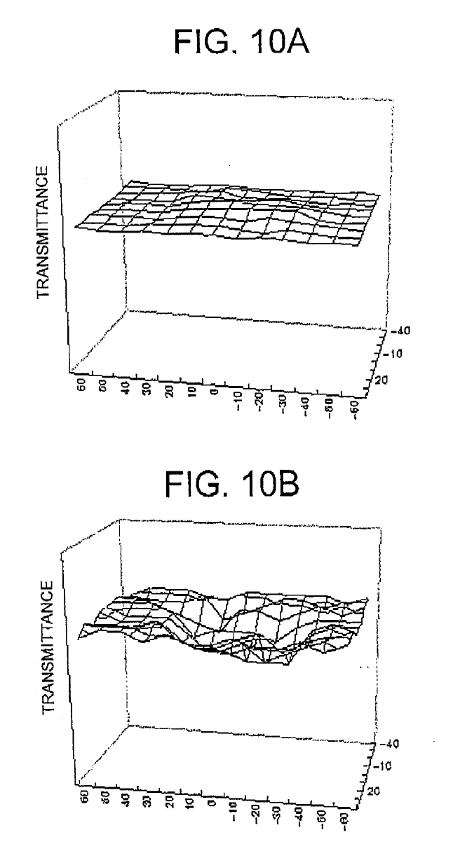

FIG. 9 shows the illuminance distribution on the exposure stage 31 without using the combination correction filter 40, and FIGS. 10A and 10B show the transmittance distribution measured from the illuminance distribution on the exposure stage 31 upon using the single correction filter 40₂ and combination correction filter 40, respectively. The range of variation in the transmittance upon using the single correction filter 40₂ shown in FIG. 10A is smaller than the range of variation in the illuminance shown in FIG. 9. Thus, the single correction filter 40₂ does not well correct the range of variation in the illuminance caused by the projection aligner 10.

FIG. 10B shows a larger range of variation in the transmittance obtained by the combination correction filter 40, compared to the case of the single correction filter 40₂ shown in FIG. 10A. The range of variation in the transmittance is roughly equivalent to the range of variation in the illuminance shown in FIG. 9. More specifically, the two correction filters 40₁, 40₂ can well correct the range of variation in the illuminance caused by the projection aligner 10. In the example of FIG. 10B, the two correction filters 40₁ and 40₂ are shifted by a shift amount a1 of 10 micrometers.

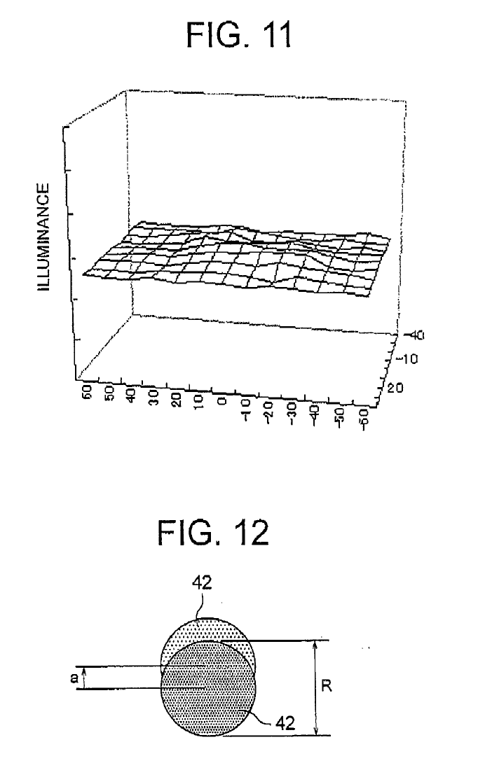

FIG. 11 shows the illuminance irregularity on the exposure stage 31 in the case where the two correction filters 40₁, 40₂ are used in the projection aligner 10, with the same shift amount a1 of 10 micrometers. The range of variation in the illuminance shown in FIG. 9 is around 5%, whereas the range of variation in the illuminance shown in FIG. 11 is around 0.8%. Thus, it is concluded that the illuminance irregularity on the exposure stage 31 is significantly improved by using the two correction filters with an exemplified shift amount of 10 micrometers.

According to the projection aligner 10 of the present embodiment, the range of variation in the transmittance can be adjusted with ease by adjusting the shift amount a1 between the two correction filters 40₁, 40₂ in the combination correction filter 40. That is, the combination correction filter 40 has the advantage of effective and easy reduction in the transmittance irregularity thereof over the single correction filter, by adjusting the shift amount between the two correction filters.

The illuminance irregularity of the projection aligner 10 changes upon degradation of the optical components of the projection aligner 10 or an exchange of an optical component therein. In the above embodiment, the combination correction filter 40 to be used in a projection aligner 10 is manufactured by using the same projection aligner 10 having the illuminance irregularity, wherein each correction filter of the combination correction filter 40 has a transmittance distribution which is opposite to the illuminance distribution of the projection aligner.

FIG. 12 shows the overall light shield pattern of the combination correction filter in a modification of the above embodiment. In this modification, the light shield pattern 42 of the first correction filter on the light incident side has a small thickness of several hundreds of angstroms, and thus has a light semi-transmissive property. The correction filter has a plurality of unit areas arranged in a grid, and each unit area configures a light semi-transmissive pattern having a unit-specific transmittance. This configuration allows a finer adjustment of the range of variation in the transmittance of the combination correction filter. It is to be noted that any one of the correction filters or both the correction filters may have the light semi-transmittance property.

In the above embodiment and modification, two correction filters are used in the combination correction filter. However, three or more of the correction filters may be included in the combination correction filter. A larger number of correction filters, if employed, may provide a larger range of variation in the transmittance. If three (first through third) correction filters are to be provided in the combination correction filter, for example, the first correction filter is fixed, the second correction filter is shifted in the direction perpendicular to the optical axis, and the third correction filter is shifted in the direction perpendicular to the optical axis and shifted direction of the second correction filter.

It is to be noted that the shift of the transmittance distribution of the first correction filter from that of the second correction filter means causing a deviation of the maximal point and minimal point of the transmittance distribution of the first correction filter from the maximal point and minimal point, respectively, of that of the second correction filter.

While the invention has been particularly shown and described with reference to exemplary embodiment and modifications thereof, the invention is not limited to these embodiment and modifications. It will be understood by those of ordinary skill in the art that various changes in form and details may be made therein without departing from the spirit and scope of the present invention as defined in the claims.

1. A projection aligner comprising:
an exposure optical system for irradiating a mask pattern with an exposure light for projecting the mask pattern onto a substrate mounted on an exposure stage; and
a plurality of correction filters juxtaposed with one another in said exposure optical system, said correction filters each having a transmittance distribution which is opposite to an inherent illuminance distribution of said exposure optical system, at least two of said correction filters are arranged so that said transmittance distributions of said at least two of said correction filters are shifted from each other in a direction perpendicular to an optical axis of said exposure optical system.

2. The projection aligner according to claim 1, wherein said correction filters each have a plurality of unit areas arranged in a grid, and said unit areas each include a light semi-transmissive pattern having a unit-specific transmittance or a light shield pattern.

3. The projection aligner according to claim 2, wherein said light semi-transmissive pattern or said light shield pattern is a circular or rectangular pattern.

4. The projection aligner according to claim 1, wherein said at least two of said correction filters have a common light transmittance distribution.

5. The projection aligner according to claim 1, wherein at least one of said correction filters includes a light semi-transmissive pattern.

6. The projection aligner according to claim 1, wherein said correction fillets filters include a first correction filter, a second filter having a transmittance distribution shifted from a transmittance distribution of said first correction filter in a direction perpendicular to said optical axis, and a third correction filter having a transmittance distribution shifted from said transmittance distribution of said first and second correction filters in a direction perpendicular to said optical axis and said shifted direction of said second correction filter.

7. A method comprising the steps:
consecutively forming a light shield film and a negative-type photoresist film on a transparent substrate;
exposing said photoresist film to an exposure light of a projection aligner including an exposure optical system and a correction optical system while using a neutral density filter in said correction optical system;
developing said exposed photoresist film to form a photoresist pattern;
patterning said light shield film by using said photoresist pattern as an etching mask to form a correction filter having a transmittance distribution which is opposite to an inherent illuminance distribution of said exposure optical system; and
iterating said steps to form a plurality of said correction filter.

8. The method according to claim 7, further comprising:
irradiating a mask pattern with an exposure light for projecting the mask pattern onto a substrate mounted on an exposure stage, said exposure light being passed by said correction filters; and
shifting at least one of said correction filters so that said transmittance distribution of said at least one of said correction filters is shifted from said transmittance distribution of another of said correction filters in a direction perpendicular to an optical axis of said exposure optical system.

9. The method according to claim 8, wherein said transmittance distributions of said at least two of said correction filters are shifted from each other so that the range of variation in overall transmittance of said correction filters approaches the range of variation in the illuminance irregularity of said exposure light.

10. A method comprising:
irradiating a mask pattern with an exposure light for projecting the mask pattern onto a substrate mounted on an exposure stage, said exposure light being passed by a plurality of correction filters each having a transmittance distribution which is opposite to an inherent illuminance distribution of said exposure optical system; and
shifting at least one of said correction filters so that said transmittance distribution of said at least one of said correction filters is shifted from said transmittance distribution of another of said correction filters in a direction perpendicular to an optical axis of said exposure optical system.
